(19) United States
(12) Patent Application Publication
(10) Pub. No.: US 2024/0140810 A1
(43) Pub. Date: May 2, 2024

(54) PROCESS FOR PREPARING A SILICATE FROM A PLANT ASH COMPRISING CRISTOBALITE USING A SALT CONTAINING A SULFUR OXYANION

(71) Applicant: RHODIA OPERATIONS, Lyon (FR)

(72) Inventors: François Payan, Paris (FR); Youssef Chkounda, Villemomble (FR)

(73) Assignee: RHODIA OPERATIONS, Lyon (FR)

(21) Appl. No.: 18/496,646

(22) Filed: Oct. 27, 2023

(30) Foreign Application Priority Data
Oct. 28, 2022 (EP) 22306640.8

(51) Int. Cl. C01B 33/32; C01B 33/187

(52) U.S. Cl. CPC C01B 33/32; C01B 33/187; C01P 2002/72

(57) ABSTRACT

The invention relates to a process for producing a silicate from a plant ash comprising crystalline silica, wherein at least a portion of said crystalline silica is cristobalite. The process comprises reacting said plant ash with a base in the presence of an additive which is a salt comprising a sulfur oxyanion. The invention also relates to a silicate obtainable from said process and to a process for preparing a precipitated silica from said silicate. The invention also concerns a reaction mixture which can be used for said processes.

### CROSS REFERENCE TO A RELATED APPLICATION

This application claims priority from European application No. 22306640.8 filed on 28 Oct. 2022, the whole content of this application being incorporated herein by reference for all purposes.

### TECHNICAL FIELD

The invention relates to a process for producing a silicate, preferably an alkali metal silicate, from a plant ash comprising crystalline silica, wherein at least a portion of said crystalline silica is cristobalite. The process comprises reacting said plant ash with a base in the presence of an additive which is a salt comprising a sulfur oxyanion. The invention also relates to a silicate obtainable from said process and to a process for preparing a precipitated silica from said silicate. The invention also concerns a reaction mixture to be used in said processes.

### TECHNICAL BACKGROUND

Silicon dioxide (SiO₂), also known as silica, is a silicon compound that is commonly found in nature. Naturally-occurring silica exists both in amorphous and crystalline forms such as cristobalite, tridymite and quartz, the latter being the major constituent of sand.

Quartz sand is frequently employed for the production of silicates, in particular sodium silicates, which can be obtained, for example, by hydrothermal treatment of quartz sand with strong bases such as sodium hydroxide or potassium hydroxide, or by fusion of quartz sand with sodium carbonate at high temperatures of around 1400-1500° C.

Sodium silicates are commonly employed as raw materials for the preparation of precipitated silica, which is a form of synthetic silica in amorphous form.

Both silicates and precipitated silica are highly versatile materials with a variety of applications in the most diverse technological fields, from constructions to detergents, tire, adhesives, food and pharmaceutical industries, and their global demand is constantly increasing.

However, the above-mentioned processes have the major disadvantages that sand, used as raw material, is not a renewable resource over human timescales as its replenishment happens through rocks erosion and weathering processes over geological time.

Moreover, the aforementioned conventional process of manufacturing silica by sand fusion requires a high consumption of energy due to the fact that the reactants need to be heated to elevated temperatures.

It appears thus clear that there remains a need to find a process for producing silicates and silica which is not only more environmentally sustainable but also cost-effective.

Rice husk is an agricultural residue of the rice milling industry and is abundant in rice producing countries. Upon burning, about 20% of the weight of the rice husk is converted into ash comprising up to 97 wt. % of silica in addition to carbon impurities and various metals in trace amounts. A portion of the silica contained in the ash is in crystalline form and the main crystalline phase is typically cristobalite.

In view of the high amount of silica contained in these ashes and their intrinsically renewable nature, many efforts have been made to try to extract silica from them as this could represent an economically feasible option for obtaining silicate and precipitated silica, which could also address the issue of appropriate disposal of rice husk (which, as mentioned before, is a waste material of the milling industry).

US 2020/0399134 describes a process for producing a sodium silicate solution from ash of burned organic matter, such rice husk ash, by washing the ash and reacting the rinsed ash in the presence of sodium hydroxide to obtain a solution of sodium silicate.

WO 2017/063901 discloses instead the preparation of a silicate by reacting rice husk ash with a silicate precursor. This document also describes the preparation of precipitated silica from the silicate thus produced.

The preparation of silica from rice husk ash is also described, for example, in WO 2004/073600 which discloses a process for the preparation of precipitated silica by the addition of an acid to a silicate solution obtained by caustic digestion of a biomass ash such as rice husk ash.

One of the criticalities of the processes that use plant ash such as rice husk ash as starting material is that, as mentioned before, the ash comprises silica which has a crystalline portion. Unlike the amorphous form, which is relatively easily attacked and dissolved when the ash is reacted in alkali conditions (e.g. alkali digestion/caustic digestion), the crystalline portion is much more difficult to dissolve and these processes often lead to low yields of silica conversion or require elevated temperatures. Another issue related to the use of plant ash concerns the fact that, being the ash a complex material, it is generally difficult to obtain a silicate that is easily separable from the rest of impurities as these often remains suspended.

Therefore, there was still the need to develop a novel process for producing silicate and precipitated silica which is environmentally friendly, cost-efficient, and with high yields.

### SUMMARY OF THE INVENTION

The present invention relates to a process for producing a silicate, preferably an alkali metal silicate, from a plant ash, wherein the process comprises a step (a) of reacting:
(i) a plant ash obtained from a combustion of a silica-containing plant part and/or plant, wherein said plant ash comprises crystalline silica and wherein at least a portion of said crystalline silica is cristobalite;
with
(ii) a base, preferably an alkali metal hydroxide;
   wherein the reaction of step (a) is carried out in a reaction mixture comprising: a dispersing medium, preferably an aqueous dispersing medium, and an additive, wherein said additive is a salt comprising a sulfur oxyanion.

According to an embodiment of the invention, the silicate is obtained in liquid form as a silicate solution, preferably an aqueous silicate solution, and the process further comprises a step (b) of separating the silicate solution obtained after step (a) from impurities deriving from the ash comprising carbon products and metals.

According to another embodiment of the invention, the silicate is obtained in solid form as a solid silicate and the process further comprises, after said step (b), a step (c) of drying the silicate solution obtained after step (b) so as to obtain a silicate in solid form.

Furthermore, the invention relates to a silicate, preferably an alkali metal silicate obtainable in liquid form as a silicate solution by the process comprising step (b) or in solid form as a solid silicate by the process comprising step (c).

Furthermore, the invention relates to a process for preparing a precipitated silica, comprising the steps of:
(I) producing a silicate solution either by the process comprising step (b) or by a process which comprises producing a silicate in solid form by the process comprising step (c) and redispersing the silicate in solid form in a dispersing medium, preferably an aqueous dispersing medium, and
(II) reacting the so-produced silicate solution and, optionally in addition, a silicate solution other than the so-produced silicate solution, NaOH, and/or a secondary silica source, with an acidifying agent to achieve precipitation of silica.

Furthermore, the invention provides a new reaction mixture for producing a silicate, preferably an alkali metal silicate, from a plant ash and/or for preparing a precipitated silica by the processes defined above, comprising:
(i) a plant ash obtained from the combustion of a silica-containing plant part and/or plant, wherein said plant ash comprises crystalline silica and wherein at least a portion of said crystalline silica is cristobalite;
(ii) a base, preferably an alkali metal hydroxide;
(iii) a dispersing medium, preferably an aqueous dispersing medium, and
(iv) an additive, wherein said additive is a salt comprising a sulfur oxyanion.

The present invention solves the aforementioned problems of the prior art by providing a process for producing a silicate and precipitated silica from a plant ash which allows improving the dissolution of the silica contained in the ash, and in particular of the crystalline portion of said silica.

Compared to the amorphous form, crystalline silica is more difficult to dissolve and, in normal alkaline digestion processes where the ash is reacted with a base, is only partially dissolved or not dissolved at all unless higher temperatures, and/or longer reaction times are employed. To solve this issue, the inventors conducted several experiments and surprisingly found that the presence of an additive, which is a salt comprising a sulfur oxyanion, within the reaction mixture of the invention, allows improving the dissolution of the crystalline silica comprised in the plant ash.

Additionally, the invention is particularly advantageous as it allows to obtain a silicate solution which can be effectively separated from the impurities deriving from the ash so to obtain the desired yield and degree of purity. Furthermore, the invention allows to reduce the crystalline silica content in the resulting waste at the end of the process (carbon cake) thus reducing potentially hazardous waste (if dried).

Furthermore, both the process for producing a silicate and the process for producing a precipitated silica according to the invention are not only environmentally friendly as they employ a plant ash (which is a renewable source) but also economically advantageously because lower temperatures can be used without affecting the overall yield.

### DETAILED DESCRIPTION OF THE INVENTION

Before the issues of the invention are described in detail, the following should be considered:

It is to be understood that this invention is not limited to particular embodiments described, since such embodiments may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise. By way of example, “an additive” means one additive or more than one additive, or “a salt” means one salt or more than one salt.

The terms “comprising”, “comprises”, and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists”, and “consists of”.

Throughout this application, the term “about” is used to indicate that a value includes the standard deviation of error for the device or method being employed to determine the value.

The terms “rice husk” and “rice hull” are used herein interchangeably. The same applies to the terms “rice husk ash” and “rice hull ash”, which are also abbreviated as RHA.

As used herein, the term “average” refers to number average unless indicated otherwise.

As used herein, the terms “% by weight”, “wt.-%”, “wt. %”, “weight percentage”, or “percentage by weight”, are used interchangeably. The same applies to the terms “% by volume”, “vol.-%”, “vol. %”, “volume percentage”, or “percentage by volume”, or “% by mol”, “mol.-%”, “mol. %”, “mol percentage”, or “percentage by mol”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75, and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different alternatives, embodiments, and variants of the invention are defined in more detail. Each alternative and embodiment so defined may be combined with any other alternative and embodiment, and this for each variant unless clearly indicated to the contrary or clearly incompatible when the value range of a same parameter is disjoined. In particular, any feature indicated as being preferred or advantageous may be combined with any other feature or features indicated as being preferred or advantageous.

Furthermore, the particular features, structures, or characteristics described in the present description may be combined in any suitable manner, as would be apparent to a person skilled in the art from this disclosure, in one or more embodiments. Furthermore, while some embodiments described herein include some but not other features included in other embodiments, combinations of features of different embodiments are mean to be within the scope of the invention, and form different embodiments, as would be understood by those in the art.

The present invention refers to a process for producing a silicate from a plant ash, wherein the process comprises a step (a) of reacting:
(i) a plant ash obtained from a combustion of a silica-containing plant part and/or plant, wherein said plant ash comprises crystalline silica and wherein at least a portion of said crystalline silica is cristobalite;
   with

(ii) a base;

wherein the reaction of step (a) is carried out in a reaction mixture comprising: a dispersing medium and an additive, wherein said additive is a salt comprising a sulfur oxyanion.

According to a preferred embodiment of the invention, said silicate is an alkali metal silicate and said base is preferably an alkali metal hydroxide.

The dispersing medium can be any suitable medium for dispersing the plant ash, the base, and/or the additive. It is preferred that said dispersing medium is an aqueous dispersing medium, more preferably water.

The sulfur oxyanion can be selected from the group consisting of sulfite [(SO₃)²⁻], sulfate [(SO₄)²⁻], peroxomonosulfate [(SO₅)²⁻], thiosulfate [(S₂O₃)²⁻], dithionite [(S₂O₄)²⁻], metabisulfite [(S₂O₅)²⁻], dithionate [(S₂O₆)²⁻], disulfate [(S₂O₇)²⁻], peroxydisulfate [(S₂O₈)²⁻], trithionate [(S₃O₆)²⁻], tetrathionate [(S₄O₆)²⁻], pentathionate [(S₅O₆)²⁻] and higher polythionates of general formula Sₙ[(SO₃)²⁻]₂ wherein n is an integer in the range of from 4 to 18. Preferably, the sulfur oxyanion is sulfate [(SO₄)²⁻].

The salt preferably comprises an alkali metal cation, an ammonium cation, or a quaternary ammonium cation of formula NR₄⁺ (where R═C₁-C₂₀, preferably C₁-C₁₀, more preferably C₁-C₅ hydrocarbon group), more preferably an alkali metal cation.

It is preferred that said salt comprises a cation selected from the group consisting of Na⁺, K⁺, Cs⁺, Li⁺, Rb⁺ and combinations thereof. More preferably, said salt comprises a cation which is Na⁺, K⁺ or a combination thereof.

Additionally, it is preferred that said salt is Na₂SO₄, K₂SO₄, or a combination thereof.

According to the invention, the reaction mixture can comprise more than one additive as defined above. In other words, the reaction mixture according to the invention can comprise more than one salt comprising a sulfur oxyanion as defined above.

According to the invention, the amount of the additive within the reaction mixture should be significantly above a catalytic amount and should be adapted depending on the level of crystalline silica which is not dissolved by alkaline digestion, i.e., by reaction of the plant ash (i) with the base (ii) and the dispersing medium (iii).

Preferably, the amount of additive within the reaction mixture is of at least 1 g/L, at least 5 g/L, at least 10 g/L, or at least 15 g/L, more preferably at least 20 g/L.

It is preferred that the amount of plant ash within the reaction mixture is of at least 10 wt. %, at least 15 wt. %, at least 20 wt. %, more preferably at least 22 wt. % by weight based on the total weight of the reaction mixture.

Additionally, the reaction mixture is preferably characterized by a ratio [SiO₂.]:[Na₂O] of 2 to 10, more preferably of 3 to 8, even more preferably of 3 to 6, most preferably of 3 to 4.

According to the invention, said reaction mixture can be formed by putting together the plant ash, the base, the dispersing medium, and the additive and/or a precursor of the additive. In fact, it has been found that the additive, which is a salt comprising a sulfur oxyanion, can be advantageously added to the reaction mixture as a salt which is already formed and/or can be formed in-situ by adding, to the reaction mixture, a precursor of the salt, especially an acid comprising a sulfur oxyanion.

Said acid comprising a sulfur oxyanion is the equivalent acid of the sulfur oxyanion mentioned above according to any of the embodiments of the present invention.

Preferably, said acid comprising a sulfur oxyanion is selected from the group consisting of sulfuric acid (H₂SO₄), sulfurous acid (H₂SO₃), peroxymonosulfuric acid (H₂SO₅), thiosulfuric acid (H₂S₂O₃), dithionous acid (H₂S₂O₄), disulfurous acid (H₂S₂O₅), dithionic acid (H₂S₂O₆), disulfuric acid (H₂S₂O₇), peroxydisulfuric acid (H₂S₂O₈), trithionic acid (H₂S₃O₆), tetrathionic acid (H₂S₄O₆), pentathionic acid (H₂S₅O₆), higher polythionic acids of general formula Sₙ[(SO₃H)₂] wherein n is an integer in the range from 4 to 18, and combinations thereof. More preferably, said acid is sulfuric acid.

When an acid comprising a multivalent anion is used as a precursor of the additive, it is understood that a sufficient amount of the base must be present in the reaction medium, not only for reacting with the plant ash but also for reacting with said acid and converting it into the additive, namely the corresponding salt of said acid.

Preferably the additive and/or an acid comprising a sulfur oxyanion can be added to the reaction mixture during step (a), and/or to the mixture obtained after a pre-dissolution step (a′) carried out before step (a), so as to form the reaction mixture according to the invention. Said pre-dissolution step (a′) comprises reacting the plant ash (i) in the presence of the base (ii) and of the dispersing medium (iii) and allows at least a partial dissolution of the plant ash. Since the plant ash is a complex material comprising not only crystalline silica but also impurities deriving from the combustion of the plant and/or plant part, it is believed that said pre-dissolution step (a′) can help obtaining an improved dissolution during subsequent step (a) in the presence of the additive and/or the acid comprising a sulfur oxyanion.

According to an embodiment of the invention, the additive and/or an acid comprising a sulfur oxyanion can be added directly to the ash before step (a′) or step (a), and/or to the plant before combustion.

According to the invention it is preferred that the base (ii) is selected from the group consisting of NaOH, KOH, LiOH, CsOH, RbOH, NH_{3(aq)} and combinations thereof, and/or has the following formula NR₄⁺OH⁻ where R═C₁-C₂₀, preferably C₁-C₁₀, more preferably C₁-C₅ hydrocarbon group. More preferably, the base is NaOH, KOH or a combinations thereof.

Additionally, it is preferred that the silicate is an alkali metal silicate which is selected from the group consisting of sodium silicate, potassium silicate or a combination thereof.

According to a particularly preferred embodiment, step (a) of the process of the invention is carried out at a reaction temperature from 120 to 250° C., preferably from 120 to 230° C., more preferably from 165 to 205° C., most preferably from 170 to 190° C.

Without wishing to be bound to a specific theory or mechanism, it has been found that the process of the invention can be surprisingly and advantageously carried out without the need to use higher temperature normally employed in the processes of the prior art and, in particular, can be carried out at temperatures from 120 to 250° C. It is believed that the presence of the additive, in combination with the other ingredients of the reaction mixture employed in the process of the invention, allows obtaining an improved dissolution of the silica comprised in the plant ash, and in particular of the crystalline portion of said silica, which, with respect to the amorphous portion is more difficult to dissolve by alkaline digestion, namely by simply reacting the ash (i) with the base (ii) and the dispersing medium (iii).

Furthermore, step (a) of the process according to the invention should be carried out for a duration sufficient to achieve dissolution of crystalline silica, in particular of the cristobalite portion of said crystalline silica. Preferably, step (a) is carried out for a reaction time of at least 10 minutes, more preferably more than 30 minutes, even more preferably more than 60 minutes, most preferably more than 90 minutes but, preferably, less than 240 minutes. More preferably said reaction time is the amount of time for which the reaction temperature of step (a) as mentioned above, is maintained.

According to an embodiment of the invention, the amount of crystalline silica is at least 0.1 wt. %, preferably at least 1 wt. %, more preferably at least 5 wt. %, at least 10 wt. %, at least 20 wt. %, at least 25 wt. %, at least 30 wt. %, at least 40 wt. %, at least 50 wt. %, at least 60 wt. %, at least 70 wt. %, at least 80 wt. %, or at least 90 wt. % based on the total silica (SiO₂) content comprised in the ash.

In an embodiment of the invention, the amount of crystalline silica is preferably from 5 to 50 wt. % based on the total silica (SiO₂) content comprised in the ash.

As mentioned above, according to the invention, at least a portion of said crystalline silica is cristobalite.

The crystalline silica, in addition to cristobalite, can also comprises quartz and/or tridymite.

According to a preferred embodiment of the invention, the majority of said crystalline silica is cristobalite, preferably at least 50 wt. %, at least 60 wt. %, at least 70 wt. % or at least 80 wt. %, more preferably at least 90 wt. %, even more preferably at least 99 wt. % most preferably about 100 wt. %, based on the total crystalline silica content.

According to a particularly preferred embodiment of the invention, the crystalline silica consists essentially of cristobalite. In this embodiment, the crystalline silica comprises only trace amounts of quartz and/or tridymite.

According to an embodiment of the invention, it is preferred that the amount of cristobalite is at least 0.1 wt. %, preferably at least 1 wt. % more preferably at least 5 wt. %, at least 10 wt. %, at least 20 wt. %, at least 25 wt. %, at least 30 wt. %, at least 40 wt. %, at least 50 wt. %, at least 60 wt. %, at least 70 wt. %, at least 80 wt. %, or at least 90 wt. % based on the total silica (SiO₂) content comprised in the ash. In an embodiment of the invention, the amount of cristobalite comprised within the plant ash is preferably from 5 to 50 wt. % based on the total silica (SiO₂) content comprised in the ash.

According to the invention, the silica-containing plant is preferably an angiosperm, more preferably a monocot or eudicot, most preferably a plant belonging to the family selected from the group consisting of Poaceae, Equisetaceae, Cyperaceae, Cucurbitaceae, Cannabaceae, Arecaceae, Brassicaceae and combinations thereof.

According to an embodiment of the invention, the silica-containing plant is a tree.

Preferably, the tree is selected from the group consisting of pine, oak, birch, elm and combinations thereof.

Preferably, the plant belonging to the family of Poaceae is selected from the group consisting of rice, wheat, sugar cane, bamboo, oat, barley, rye, sorghum, triticale, reed canary grass, reed, corn, miscanthus and combinations thereof.

Preferably, the plant belonging to the family of Equisetaceae is field horsetail.

Preferably, the plant belonging to the family of Cyperaceae is sedge.

Preferably, the plant belonging to the family of Cucurbitaceae is selected from the group consisting of melon, watermelon, squash, cucumber and combinations thereof.

Preferably, the plant belonging to the family of Cannabaceae is hemp.

Preferably, the plant belonging to the family of Arecaceae is palm tree.

Preferably, the plant belonging to the family of Brassicaceae is rapeseed.

It is preferred that the silica-containing plant is a plant selected from the group consisting of rice, wheat, rapeseed, barley, bamboo, field horsetail, sedge, watermelon and combinations thereof.

According to the invention, the plant ash is obtained from a combustion of a silica-containing plant part and/or plant.

Preferably, the part of a silica-containing plant (i.e., silica-containing plant part) is selected from the group consisting of a root, a stem, a leaf, a flower, a fruit, a husk, a culm, a stalk, wood and combinations thereof.

According to the invention, the part of the silica-containing plant can also derive from a processing of the plant, such as straw (e.g. cereals straw), bagasse (e.g. sugar cane bagasse), oil (e.g. palm oil), sawdust (e.g. tree sawdust), and/or pellet.

It is preferred that said plant part is selected from the group consisting of rice husk, rice straw, wheat husk, wheat straw, barley straw, barley husk, sugar cane bagasse, sugar cane leaves, bamboo stem, bamboo leaves, corncob, palm tree oil, miscanthus stalk, miscanthus leaves, sedge leave, watermelon fruit, tree wood and combinations thereof.

In a particularly preferred embodiment of the invention, the silica-containing plant is rice and, preferably, the part of said silica-containing plant is a husk.

According to the invention, rice husk, is particularly preferred as, once burned, the ash contains a relatively high amount of silica which is preferably of at least 5 wt. %, more preferably at least 10 wt. %, most preferably at least 15 wt. % based on the total weight of the ash.

According to the invention, the combustion of a silica-containing plant part and/or plant is carried out by conventional techniques by burning a part of a plant and/or a plant containing silica.

According to an embodiment, the silica-containing plant part and/or plant can be subjected to at least one pre-treatment. Preferably, said at least one pre-treatment is washing with water, more preferably washing with acidified water.

Preferably, a compound selected from the group consisting of Na₂CO₃, K₂CO₃, NaOH, KOH, Na₂SO₄, K₂SO₄ and combinations thereof, and/or any other similar compound known to a person skilled in the art can be added to the silica-containing plant part and/or plant before combustion to reduce the quantity of crystalline silica thus generated. Preferably, if said pre-treatment is carried out, said compound is added to the silica-containing plant part and/or plant after said pre-treatment.

Preferably, the combustion of the silica-containing plant part and/or plant is carried out at a temperature from 300 to 1500° C., preferably from 500 to 1000° C. According to an embodiment, the combustion of the silica-containing plant part and/or plant is carried out at a temperature of at least 700° C., preferably at a temperature from 700° C. to 1000° C., said silica-containing plant part and/or plant preferably containing a compound selected from the group consisting of Na₂CO₃, K₂CO₃, NaOH, KOH, Na₂SO₄, K₂SO₄, and combinations thereof as described above.

According to another embodiment, the combustion of the silica-containing plant part and/or plant is carried out at a temperature lower than 700° C., preferably at a temperature from 500° C. up to less than 700° C.

According to an embodiment, the plant ash, before being employed in step (a) and/or (a′) of the process of the invention, is subjected to at least one pre-treatment. Preferably, said at least one pre-treatment is or comprises washing with water and/or washing with acidified water; more preferably, it is or comprises washing with acidified water.

Additionally, according to an embodiment, a compound selected from the group consisting of Na₂CO₃, K₂CO₃, NaOH, KOH, Na₂SO₄, K₂SO₄ and combinations thereof, and/or other similar compounds known to a person skilled in the art, can be added to the plant ash before being employed in step (a) and/or (a′). Preferably, if said pre-treatment is carried out, said compound is added to the plant ash after said pre-treatment.

According to the invention, the silicate is preferably in the form of a silicate solution, more preferably an aqueous silicate solution, and the process of the invention can further comprise, after step (a) as described above, a step (b) of separating the silicate solution obtained after step (a) from the impurities deriving from the ash comprising carbon products and metals.

Said metals are for example metals (and/or metalloids) selected from the group consisting of metals of the boron group (in particular B and/or Al), alkali metals (in particular K), alkaline earth metals (in particular Ca and/or Mg), transition metals (in particular at least one of Fe, Mn, Ni, Ti and/or Zn) and combinations thereof.

According to an embodiment said impurities deriving from the ash can comprise further chemical elements selected from the group consisting of pnictogens (in particular P and/or As), halogens (in particular Cl) and a combination thereof.

According to the invention, said impurities can be present within the silicate solution as undissolved solids and/or in solvated form.

According to another embodiment, the silicate is in the form of a solid silicate and the process of the invention further comprises, after step (b), a step (c) of drying the silicate solution obtained after step (b) so as to obtain a silicate in solid form.

Preferably, the drying of the silicate solution obtained after step (b) is carried out by a conventional drying technique.

Said conventional drying technique is preferably selected from the group consisting of turbine drying, spin-flash drying, atomization, spray-drying and combinations thereof.

Additionally, it is preferred that said conventional drying technique is carried out in the absence of oxygen and/or in a short time to avoid oxidation and degradation of the product.

The invention further relates to a silicate, preferably an alkali metal silicate, obtainable in liquid form as a silicate solution, by the process described above comprising step (b). Preferably said silicate solution is an aqueous silicate solution.

Preferably, said silicate solution is a solution characterized by a silicate content of at least 5 wt. %, more preferably at least 10 wt. %, even more preferably at least 15 wt. %, most preferably at least 20 wt. %, even most preferably at least 22 wt. % by weight based on the total weight of the solution.

Additionally, it is preferred that said silicate solution is a solution characterized by a ratio [SiO₂]:[Na₂O] of 2 to 10, more preferably of 3 to 8, even more preferably of 3 to 6, most preferably of 3 to 4. Without wishing to be bound to a specific theory, it has been found that, when the silicate solution is employed for the production of precipitated silica, said ratio allows to advantageously have an efficient silica synthesis as it leads to a good yield, defined structure and limited salt generation.

The invention further relates to a silicate, preferably an alkali metal silicate, obtainable in solid form as a solid silicate by the process described above comprising step (c).

Preferably said solid silicate is characterized by a ratio [SiO₂]:[Na₂O] of 2 to 10, more preferably of 3 to 8, even more preferably of 3 to 6, most preferably of 3 to 4.

Additionally, it is preferred that said solid silicate is characterized by a humidity of at most 10%.

More preferably, said solid silicate is characterized by a granulometry of at least 100 μm.

The invention also concerns a process for preparing a precipitated silica, comprising the steps of:
(I) producing a silicate solution either by the process described above comprising step (b) or by a process which comprises producing a silicate in solid form by the process described above comprising step (c) and redispersing the silicate in solid form thus obtained in a dispersing medium; and
(II) reacting the so-produced silicate solution and, optionally, in addition, a silicate solution other than the so-produced silicate solution, NaOH, and/or a secondary silica source, with an acidifying agent to achieve precipitation of silica.

Preferably, said dispersing medium is an aqueous dispersing medium, more preferably water, and the silicate solution obtained after step (I) to be employed in step (II) is an aqueous silicate solution.

According to an embodiment of the invention, step (II) comprises adding to the silicate solution produced according to step (I), i.e. the so-produced silicate solution, a silicate solution other than the so-produced silicate solution, NaOH, and/or a secondary silica source to adjust the [SiO₂.]:[Na₂O] ratio of the silicate and, in turn, of the final precipitated silica.

According to the invention, the silicate solution other than the so-produced silicate solution is a silicate solution produced by any conventional process other than the process of the present invention.

According to the invention, said secondary silica source is a silica produced by any conventional process other than the process of the present invention and/or naturally occurring silica. Preferably, said secondary silica source is amorphous silica.

The acidifying agent can be a mineral acid, an organic acid or a combination thereof. The mineral acid is preferably selected from the group consisting of sulfuric acid (H₂SO₄), hydrochloric acid (HCl), nitric acid (HNO₃), phosphoric acid (H₃PO₄) and combinations thereof. The organic acid is preferably selected from the group consisting of acetic acid, formic acid, carbonic acid and combinations thereof.

In a preferred embodiment of the invention, the acidifying agent is sulfuric acid and the process comprises a further step (III) of separating the salt containing a sulfate anion (SO₄²⁻) obtained after the precipitation reaction of silica, in solid or liquid form. In a more preferred embodiment, said salt containing a sulfate anion obtained after step (III) is recycled by adding it into the reaction mixture of step (a) of the process of the invention.

Without wishing to be bound to a specific theory or mechanism, it has been found that, at the end of the process for preparing a precipitated silica, when sulfuric acid is employed as the acidifying agent, a salt containing a sulfate anion is obtained, which can be advantageously employed as the additive according to the invention, by adding it into the reaction mixture used in step (a) of the process of the invention so to advantageously obtain a circular process.

Furthermore, the invention relates to a reaction mixture for producing a silicate, preferably an alkali metal silicate, from a plant ash by the process as defined above comprising step (a) (possibly steps (a) and (b), possibly steps (a), (b) and (c)), and/or for preparing a precipitated silica by the process as defined above comprising steps (I) and (II) (possibly steps (I), (II) and (III)).

The reaction mixture comprises:
(i) a plant ash obtained from the combustion of a silica-containing plant part or plant, wherein said plant ash comprises crystalline silica and wherein at least a portion of said crystalline silica is cristobalite;
(ii) a base;
(iii) a dispersing medium; and
(iv) an additive, wherein said additive is a salt comprising a sulfur oxyanion.

Preferably, the plant ash (i), the base (ii), the dispersing medium (iii) and the additive (iv) are as described above according to any one of the embodiments of the present invention.

The present invention will now be illustrated by the following examples, which are not intended to be limiting.

### EXAMPLES

### Materials and Methods

All starting materials used in the examples are commercially available. For all examples, a rice husk ash (RHA) having the following characteristics, was employed:
Silica content as measured by Assay purity method: 83.1% over total sample;
Cristobalite content as measured by XRD: 40% over total SiO₂ content;
Carbon content as measured by Carbon/sulfur Analysis: 13.5% over total SiO₂ content.

### Determination of the Content of Cristobalite and Carbon

The determination of the content of cristobalite fraction in each sample was performed with the following procedure, which was divided in two parts: the first one was dedicated to the creation of the calibration curve, while the second part was dedicated to the preparation of the samples, the analysis, and the calculation of the cristobalite content by XRD.

### XRD Analyzer

The diffractometer employed for the experiments was a X'Pert Pro from Malvern-Panalytical with the following configuration:

Copper X-ray tube, reflection, Bragg-Brentano configuration, Bragg-Brentano HD mirror, ⅛° divergence slit, 4 mm mask, 0.02 rad front Soller slit, ¼° front anti-scattering slit, 0.02 rad rear Soller slit, ¼° rear anti-scattering slit, X Celerator detector, 1 rotation of the sample holder per second.

### Calibration Curve

The standard samples employed for the calibration curve was prepared with the following raw materials:
Cristobalite provided by Solvay (no 22MAU302), 66.6 wt %+/−2.5 wt % pure. It also contained tridymite and amorphous silica
Amorphous silica provided by Solvay (no 19STD078)
α-Al₂O₃ (purity>99%)
   9 samples with different cristobalite amounts and constant α-Al₂O₃ amounts (20 wt %) were prepared as shown in Table 1 below. The following steps were followed to prepare each sample:
30 minutes of mixing in a Turbula shaker;
Hand grinding of the powder with agate mortar and pestle;
30 minutes of mixing in a Turbula shaker.

TABLE 1

| | Mass of | | | | | |
|---|---|---|---|---|---|---|
| | amorphous | | | Mass | | |
| | silica | Mass of | | of α- | Total | Wt % |
| | 19STD078 | 22MAU302 | wt % | Al₂O₃ | mass | α- |
| | (g) | (g) | cristobalite | (g) | (g) | Al₂O₃ |
| Sample | 0 | 1.6 | 66 | 0.40 | 2.00 | 20.00 |
| 1 | | | | | | |
| Sample | 0.5 | 1.1 | 45.375 | 0.40 | 2.00 | 20.00 |
| 2 | | | | | | |
| Sample | 0.7 | 0.9 | 37.125 | 0.40 | 2.00 | 20.00 |
| 3 | | | | | | |
| Sample | 0.9 | 0.7 | 28.875 | 0.40 | 2.00 | 20.00 |
| 4 | | | | | | |
| Sample | 1.1 | 0.5 | 20.625 | 0.40 | 2.00 | 20.00 |
| 5 | | | | | | |
| Sample | 1.25 | 0.35 | 14.4375 | 0.40 | 2.00 | 20.00 |
| 6 | | | | | | |
| Sample | 1.4 | 0.2 | 8.25 | 0.40 | 2.00 | 20.00 |
| 7 | | | | | | |
| Sample | 1.5 | 0.1 | 4.125 | 0.40 | 2.00 | 20.00 |
| 8 | | | | | | |
| Sample | 1.55 | 0.05 | 2.0625 | 0.40 | 2.00 | 20.00 |
| 9 | | | | | | |

For each of the 9 samples, 3 XRD sample holders of 16 mm diameter were prepared with back loaded sample holders.

Each XRD sample holder was analyzed from 20=33° to 40° at 200 seconds per step, step size 0.017°.

The HighScore Plus 4.8 software was used to measure the area of the peaks at 35.14° for the Al₂O₃ and the combined areas of the peaks at 36.08° and 38.38° for the cristobalite.

The calibration curve area ratio between cristobalite peaks and Al₂O₃ peaks was established as function of the weight percentage of cristobalite in the samples.

### Preparation of the Samples and Quantification

For each measure, two preparations were done to ensure representativeness of the quantification following the same procedure described below.

1.2 g of the sample was weighed in a glass vial and 0.3 g of α-Al₂O₃ were added. The following steps were followed to ensure an homogeneous mixing:
30 minutes of mixing in a Turbula shaker;
Hand grinding of the powder with agate mortar and pestle;
30 minutes of mixing in a Turbula shaker.
   For each preparation, 16 mm diameter back loaded XRD sample holders were charged and analyzed following the following analytical method; 2θ=33° to 40° at 200 seconds per step, step size 0.017°, Copper X-ray tube, reflection, Bragg-Brentano configuration, Bragg-Brentano HD mirror, ⅛° divergence slit, 4 mm mask, 0.02 rad front Soller slit, ¼° front anti-scattering slit, 0.02 rad rear Soller slit, ¼° rear anti-scattering slit, X Celerator detector, 1 rotation of the sample holder per second. The HighScore Plus 4.8 software was used to measure the area of the peaks.

The ratio of the combined area of the 2 cristobalite peaks (at 36.08° and) 38.38° and the area of the Al₂O₃ peak at 35.14° was used to determine the cristobalite content by using the calibration curve.

### Carbon/Sulfur Analysis

A 200 mg sample was analyzed in Horiba EMIA 320-V2. Lecocel®, iron and tin balls are used as combustion accelerators. CS26—3.19% was used to calibrate the sensor.

### Assay Purity Analysis

1 g of sample was ignited in a tared platinum dish at 1000° C. for 1 hour, cooled in a desiccator and weighed. The resulting solid was wet with water, 10 mL of hydrofluoric acid were added in small increments. The mixture was then evaporated in a steam bath to dryness and then cooled. 10 mL of hydrofluoric and 0.5 mL of sulfuric acid were added and then evaporated to dryness. The temperature was then slowly increased until all of the acids were volatilized. The sample was then ignited at 1000° C., cooled in a desiccator and then weighed. The ratio between the difference of the final weight and the weight of the initially ignited portion on the one hand and the weight of the original sample on the other hand represented the weight percentage of SiO₂.

### Potentiometry

A Titrando 808 was used in order to determine the weight ratio (Rp) [% weight (SiO₂)/% weight (Na₂O)]. The device was equipped with a reference electrode Ag/AgCl in KCl 3M and a working electrode in tungsten. Each Rp was measured in duplicate and the Rp values present were the average between the two measurements.

0.5 g of sample was weighed and completed with 30 mL of demineralized water. The titration solution was a 0.1N HCl solution. The volume V1 (mL) was determined as the equivalence of the titration. After the equivalence, 0.5 mL of titration solution was added.

Afterward, 50 mL of KF solution (50 g/l of KF in a water/ethanol (50/50) solution) was added and allowed to react for 3 minutes. Then, 15 mL of 0.1N HCl solution was added. The excess of HCl was titrated by a NaOH 1N solution and the volume V2 (mL) was the equivalent point of the titration.

The Rp is then calculated following the formula below:

Rp=(0.31*V1)/(1.5(15*1−V2*1)+(0.5*0.1))

### Example 1—Comparative Example without any Additive

In a stirred PARR combustion bomb the following reagents were introduced: 50 mL of NaOH solution at 104 g/L and 16.4 g of RHA. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Example 2 and 2Bis—Use of K₂SO₄ as the Additive According to the Present Invention

Example 2bis was a repetition of example 2.

In a stirred PARR combustion bomb the following reagent were introduced: 50 mL of NaOH at 104 g/L, 1.115 g of K₂SO₄, and 16.4 g of RHA. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Example 3—Use of Na₂SO₄ as the Additive According to the Present Invention

In a stirred PARR combustion bomb the following reagent were introduced: 50 mL of NaOH at 104 g/L, 0.910 g of Na₂SO₄, and 16.4 g of RHA. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Example 4—Comparative Example with KCl as an Additive

In a stirred PARR combustion bomb the following reagent were introduced: 50 mL of NaOH at 104 g/L, 0.955 g of KCl, and 16.4 g of RHA. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Results

The results obtained with each experiment performed according to Examples 1˜4 are shown in Table 1 below.

“Rp target” means the theoretical Rp (SiO₂/Na₂O) in weight based on the quantity of NaOH wt. % and SiO₂ wt. % (from RHA) introduced.

“Rp” is the measured ratio by potentiometric technique.

TABLE 2

| | | | Yield (Rp | Max yield in case of |
|---|---|---|---|---|
| | Rp | | measured/Rp | non-crystalline silica |
| Example | target | Rp | target) | digestion |
| 1 | 3.4 | 1.59 | 47% | 60% |
| 2 | 3.4 | 3.1 | 91% | 60% |
| 2 bis | 3.4 | 3.13 | 92% | 60% |
| 3 | 3.4 | 2.94 | 86% | 60% |
| 4 | 3.4 | 1.63 | 48% | 60% |

Example 1 (for comparison purposes) showed that at a reaction temperature of 180° C., without any additive, crystalline silica, including cristobalite, cannot be dissolved. Example 4 (also for comparison purposes) demonstrated that not all salts are suitable additives for improving the dissolution of crystalline silica: the use of a salt comprising a monovalent anion, such as KCl, did not lead to the effective dissolution of the crystalline silica.

On the contrary, the use of a salt comprising a sulfur oxyanion, such K₂SO₄ or Na₂SO₄ according to the present invention (as shown in Examples 2, 2 bis and 3), led to a much higher Rp for the same reaction temperature of 180° C. and to a significant increase in the SiO₂ dissolution yield up to >86%. This clearly showed that the use of a salt comprising a sulfur oxyanion, such K₂SO₄ or Na₂SO₄, as an additive according to the process of the present invention, greatly improves the dissolution level of cristobalite and total silica even at lower temperatures such as 180° C.

1. A process for producing a silicate from a plant ash, wherein the process comprises a step (a) of reacting:
(i) a plant ash obtained from a combustion of a silica-containing plant part and/or plant, wherein said plant ash comprises crystalline silica and wherein at least a portion of said crystalline silica is cristobalite;
with
(ii) a base;
wherein the reaction of step (a) is carried out in a reaction mixture comprising a dispersing medium and an additive,
wherein said additive is a salt comprising a sulfur oxyanion.

2. The process according to claim 1, wherein the silicate is an alkali metal silicate.

3. The process according to claim 1, wherein the base is an alkali metal hydroxide.

4. The process according to claim 1, wherein the dispersing medium is an aqueous dispersing medium.

5. The process according to claim 1, wherein said sulfur oxyanion is selected from the group consisting of sulfite [(SO₃)²⁻], sulfate [(SO₄)²⁻], peroxomonosulfate [(S₅)²⁻], thiosulfate [(S₂O₃)²⁻], dithionite [(S₂O₄)²⁻], metabisulfite [(S₂O₅)²⁻], dithionate [(S₂O₆)²⁻], disulfate [(S₂O₇)²⁻], peroxydisulfate [(S₂O₈)²⁻], trithionate [(S₃O₆)²⁻], tetrathionate [(S₄O₆)²⁻], pentathionate [(S₅O₆)²⁻], higher polythionates of general formula Sₙ[(SO₃)²⁻]₂ wherein n is an integer in the range of from 4 to 18, and combinations thereof.

6. The process according to claim 5, wherein said sulfur oxyanion is sulfate (SO₄²⁻).

7. The process according to claim 1, wherein said salt comprises a cation selected from the group consisting of alkali metal cations, ammonium cation, quaternary ammonium cations of formula NR₄⁺ where R═C₁-C₂₀ hydrocarbon group and combinations thereof.

8. The process according to claim 7, wherein said salt is Na₂SO₄, K₂SO₄ or a combination thereof.

9. The process according to claim 1, wherein said reaction mixture is formed by putting together the plant ash, the base, the dispersing medium, and the additive and/or an acid comprising a sulfur oxyanion.

10. The process according to claim 1, wherein step (a) is carried out at a reaction temperature from 165 to 205° C.

11. The process according to claim 10, wherein step (a) is carried out at a reaction temperature from 170 to 190° C.

12. The process according to claim 1, wherein the amount of crystalline silica is at least 30 wt. % based on the total SiO₂ content comprised in the ash, the amount of cristobalite is at least 20 wt. % based on the total SiO₂ content comprised in the ash, and the majority of crystalline silica is cristobalite.

13. The process according to claim 1, wherein the silica-containing plant is selected from the group consisting of rice, wheat, rapeseed, barley, bamboo, field horsetail, sedge, watermelon and combinations thereof.

14. The process according to claim 1, wherein the plant ash is rice husk ash.

15. The process according to claim 1, wherein the silicate is in the form of a silicate solution and wherein the process further comprises a step (b) of separating the silicate solution from the impurities deriving from the ash, said impurities comprising carbon products and metals.

16. The process according to claim 15, further comprising a step (c) of drying the silicate solution obtained after step (b) so as to obtain a silicate in solid form.

17. A process for preparing a precipitated silica, comprising the steps of:
(I) producing a silicate solution by the process according to claim 15, and
(II) reacting the so-produced silicate solution and, optionally in addition at least one of a silicate solution other than the so-produced silicate solution, NaOH and a secondary silica source, with an acidifying agent to achieve precipitation of silica.

18. The process according to claim 17, wherein the acidifying agent is sulfuric acid, a salt containing a sulfate anion is concurrently formed with the precipitated silica, and the process comprises a step (III) of separating the salt containing a sulfate anion in solid or liquid form.

19. The process according to claim 18, which further comprises recycling the salt containing a sulfate anion obtained after the precipitation reaction into step (a).

20. A process for preparing a precipitated silica, comprising the steps of:
(I) producing a silicate solution by a process which comprises producing a silicate in solid form by the process according to claim 16 and redispersing the silicate in solid form in a dispersing medium, and
(II) reacting the so-produced silicate solution and, optionally in addition at least one of a silicate solution other than the so-produced silicate solution, NaOH and a secondary silica source, with an acidifying agent to achieve precipitation of silica.
